(19) United States
(12) Patent Application Publication
(10) Pub. No.: US 2009/0126001 A1
(43) Pub. Date: May 14, 2009

(54) TECHNIQUES TO MANAGE SECURITY CERTIFICATES

(75) Inventors: Anton W. Krantz, Kirkland, WA (US); Niraj Khanchandani, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/936,967

(22) Filed: Nov. 8, 2007

(51) Int. Cl. G06F 21/00

(52) U.S. Cl. 726/10

(57) ABSTRACT

Techniques to manage security certificates are described. An apparatus may comprise a certificate proxy server having a transceiver and a certificate manager module. The certificate manager module may be operative to register a digital identity certificate for a call terminal to perform authentication operations on behalf of the call terminal, and manage the digital identity certificate for the call terminal. Other embodiments are described and claimed.

### BACKGROUND

Communications networks are convenient since they provide a host of network services to geographically distributed network devices. Such convenience typically requires security techniques to ensure a network device has legitimate access to a given service in order to avoid fraudulent or criminal activity. For example, one network device may need to authenticate its identity to another network device prior to approving access to certain network services.

One common authentication technique is to provide a password. With the proliferation of diverse network services, however, a user or operator may need to remember or maintain a larger number of passwords, which may be tedious and inconvenient. Further, in some cases a password may be stored by the device, or sent over the network, thereby making the password vulnerable to compromise.

Another common authentication technique is the use of security certificates. Security certificates are convenient since they can be used to perform automated authentication operations with limited operator intervention. Security certificates periodically require various certificate management operations, however, which may need manual intervention for installation, renewal and removal. Consequently, there may be a need for improved authentication techniques to authenticate a network device with a network service.

### SUMMARY

Various embodiments may be generally directed to a communications network. Some embodiments may be particularly directed to techniques for managing security certificates for various devices within a communications system. In one embodiment, for example, an apparatus may comprise a certificate proxy server having a transceiver and a certificate manager module. The certificate manager module may be operative to register a security certificate such as a digital identity certificate for a call terminal to perform authentication operations on behalf of the call terminal. For example, the certificate manager module may authenticate the call terminal using the digital identity certificate to establish a media channel over a packet-switched network for a communications session. The certificate manager module may also be operative to manage the digital identity certificate for the call terminal. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of a communication system.

FIG. 2 illustrates one embodiment of a first message flow.

FIG. 3 illustrates one embodiment of a second message flow.

FIG. 4 illustrates one embodiment of a third message flow.

FIG. 5 illustrates one embodiment of a logic flow.

FIG. 6 illustrates one embodiment of a computing system architecture.

### DETAILED DESCRIPTION

Various embodiments may be directed to improved techniques for managing security certificates for various network devices within a communications system. Security certificates provide an operator or user a convenient technique to authenticate a network device to a service while reducing or eliminating operator intervention. Although convenient, security certificates are management intensive and periodically require various certificate management operations, such as installing a security certificate to a network device, retrieving a security certificate from a certificate authority, accessing a security certificate, monitoring a security certificate for expiration, renewing a security certificate, revoking an expired security certificate, and so forth. Such certificate management operations typically require manual intervention for installation, renewal, removal and so forth. In addition, this might not be a trivial implementation for embedded devices which are not open for manual process execution. Furthermore, such certificate management operations may require ubiquitous access to a network device to perform such certificate management operations. This may be particularly unsuitable for network appliances that typically remain in an inactive state until an operator manually activates the network appliance, such as a Voice Over Packet (VOP) or Voice Over Internet Protocol (VoIP) (collectively referred to herein as “VoIP”) device.

Various embodiments attempt to retain the automated convenience of security certificates for such devices while reducing or eliminating these and other disadvantages associated with certificate management operations. Some embodiments may utilize a certificate proxy server to receive a security certificate from a client device. The certificate proxy server may perform authentication operations and certificate management operations with the security certificate on behalf of the client device. One example of a client device may include without limitation a network device such as a VoIP call terminal. The communications system may comprise, for example, a packet-switched network offering network services requiring authentication services. The authentication services may include any desired cryptographic scheme suitable for a desired level of security. The network services may comprise any desired network services, such as logging into a network, accessing another network device, establishing multimedia communications sessions between call terminals using various VoIP techniques, and so forth.

The certificate proxy server operates as a proxy for the client device to perform authentication operations and certificate management operations. This may provide several advantages over conventional techniques. For example, the use of a certificate proxy server may reduce processing and memory requirements for the client device. Further, the client device may remain in an inactive state until needed, thereby reducing power consumption, device maintenance and associated costs. In addition, the certificate proxy server may be implemented as a high-availability device thereby allowing the certificate proxy server to perform certificate management operations when necessary, such as when authentication credentials obtained using the security certificate expire after a predetermined amount of time or number of uses.

The certificate proxy server may be implemented using any number of different network devices. In one embodiment, for example, the certificate proxy server may be implemented as a Session Initiation Protocol (SIP) server. A SIP server provides a set of well known set of authentication and registration operations, thereby making a SIP server an attractive host for certificate proxy operations. It may be appreciated, however, that other network devices and protocol servers may be implemented as the certificate proxy server as well. The embodiments are not limited in this context.

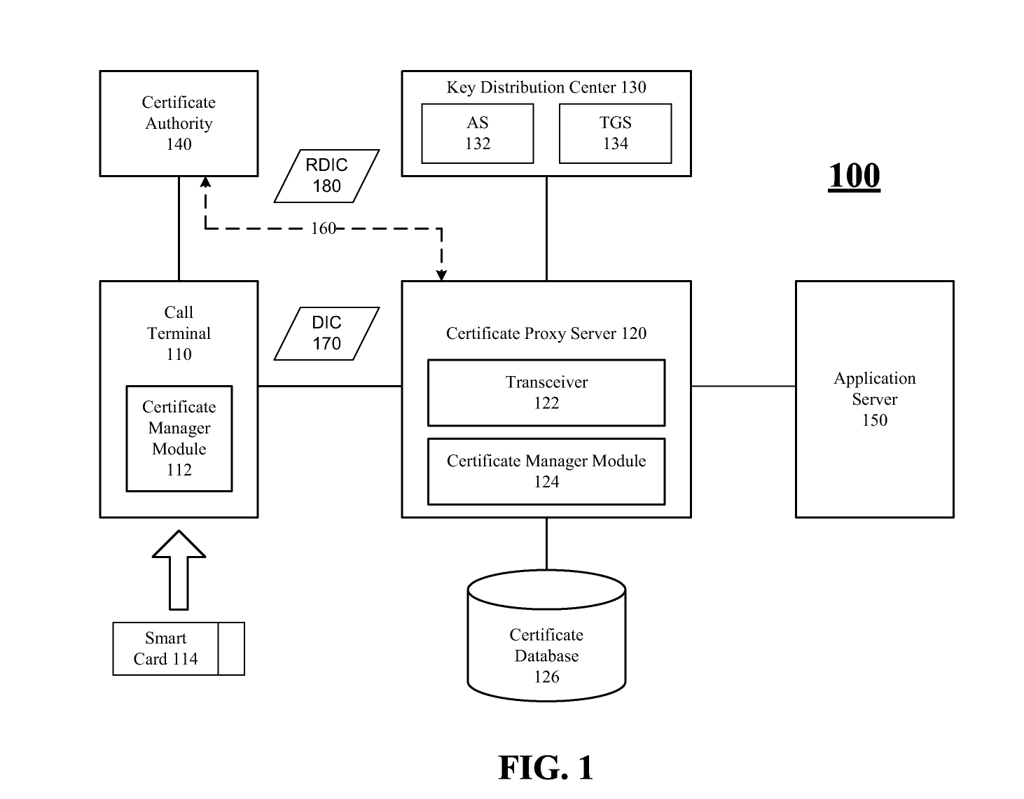

FIG. 1 illustrates one embodiment of a communications system 100. The communications system 100 may represent a general system architecture suitable for implementing various embodiments. The communications system 100 may comprise multiple elements. An element may comprise any physical or logical structure arranged to perform certain operations. Each element may be implemented as a hardware element, a software element, or any combination thereof, as desired for a given set of design parameters or performance constraints. Examples of hardware elements may include without limitation devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include without limitation any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the communications system 100 as shown in FIG. 1 has a limited number of elements in a certain topology, it may be appreciated that the communications system 100 may include more or less elements in alternate topologies as desired for a given implementation. The embodiments are not limited in this context.

In various embodiments, portions of the communications system 100 may be implemented as a packet-switched network, a circuit-switched network, or a combination of both. A packet-switched network may comprise any network capable of transporting information in discrete data units utilizing various packet-switched protocols, such as the Transport Control Protocol (TCP), User Datagram Protocol (UDP), and Internet Protocol (IP), and various VoIP protocols, to name just a few. Examples of a packet-switched network may include the public Internet and private enterprise networks. A circuit-switched network may include any network capable of transporting call information utilizing various circuit-switched protocols, such as Pulse Code Module (PCM). Examples of a circuit-switched network may include the Public Switched Telephone Network (PSTN), a private voice network, and so forth.

In the illustrated embodiment shown in FIG. 1, the communications system 100 may include one or more client devices. The client devices may comprise or be implemented as any electronic device having communications capabilities. In one embodiment, for example, the client device may be implemented as a call terminal 110. The call terminal 110 may comprise or be implemented as any electronic device having call capabilities. Examples of call terminal 110 may include without limitation a phone, a telephone, an analog telephone, a digital telephone, a VoIP telephone, an Internet telephone, an Internet Protocol (IP) telephone, a cellular telephone, a smart phone, a combination cellular telephone and personal digital assistant (PDA), a soft telephone (e.g., a processing device executing call software), and so forth. In one embodiment, for example, the call terminal 110 may comprise a VoIP telephone implemented as an integrated device or network appliance similar to a traditional plain old telephone service (POTS) telephone. The embodiments, however, are not limited to this example.

In various embodiments, the communications system 100 may include a certificate proxy server 120. The certificate proxy server 120 may comprise or be implemented as any electronic device having processing, memory and communications capabilities sufficient to authenticate and manage one or more security certificates for the call terminal 110 in accordance with the security infrastructure for a given network environment. Examples for the certificate proxy server 120 may be implemented on any type of processing device, such as a computer, a personal computer, a laptop computer, a server, a work station, a media server, a network appliance, consumer electronics, and so forth. Any processing device may be suitable for modification as a certificate proxy server as long as it is ubiquitously available to the client device (e.g., the call terminal 110) and the security infrastructure.

In one embodiment, the certificate proxy server 120 may be implemented as a network server configured to communicate control and media information over a packet-switched network. For example, the certificate proxy server 120 may be implemented as a network server arranged to establish a VoIP telephone call or conference call using a VoIP signaling protocol as defined and promulgated by the Internet Engineering Task Force (IETF) standards organization.

In one embodiment, for example, the certificate proxy server 120 may be implemented as a Session Initiation Protocol (SIP) network element, such as a SIP proxy server as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include IP telephone calls, multimedia distribution, and multimedia conferences. A SIP proxy server is a SIP network element specifically designed to route requests to a user's current location, authenticate and authorize users for services, implement provider call-routing policies, provide features to users, and so forth. When the certificate proxy server 120 is implemented as a SIP network element, the call terminal 110 may be implemented as corresponding SIP network elements as well, such as SIP user agents, for example. Other suitable network elements for the certificate proxy server 120 may include network devices implementing various network protocols, such as an Extensible Messaging and Presence Protocol (XMPP) server, a web server using a Simple Object Access Protocol (SOAP), an International Telecommunication Union Telecommunication Standardization Sector (ITU-T) H.323 server, a Media Gateway Control Protocol (MGCP) server, and so forth. The embodiments are not limited in this context.

A SIP proxy server is particularly suitable for implementation as the certificate proxy server 120 since it is ubiquitously available across a wide area network (WAN). Furthermore, a SIP proxy server is typically part of the same signaling path used to establish a multimedia communications session between the call terminal 110 and another network device, such as another call terminal. Consequently, this may reduce the number of additional signal paths needed for the SIP proxy server to perform certain authentication operations on behalf of the call terminal 110. Although some embodiments describe the certificate proxy server 120 implemented as part of a SIP proxy server by way of example and not limitation, the embodiments are not necessarily limited to any particular SIP network element, or any other network elements using different VoIP signaling and transport protocols. It may be appreciated that the certificate proxy server 120 may be implemented as part of any network device separate from the client device (e.g., call terminal 110) and that is ubiquitously available to the client device and the security infrastructure for a given network environment.

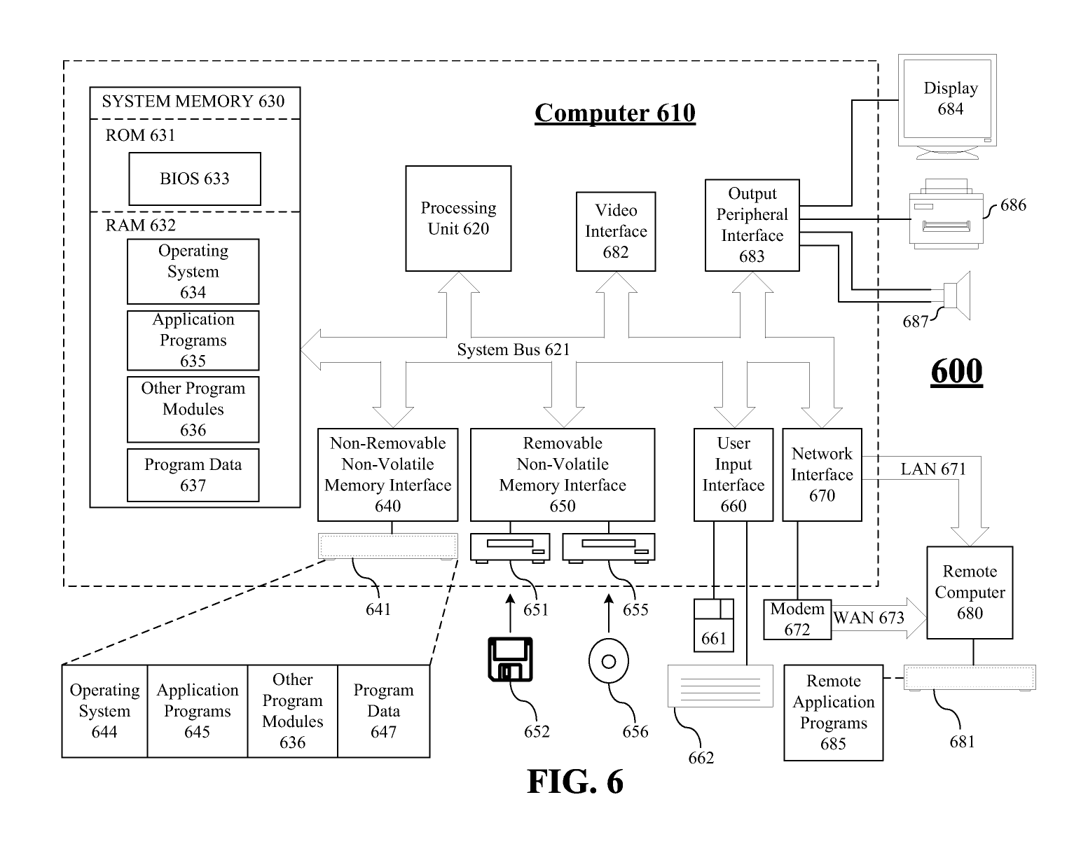

As shown in FIG. 1, one embodiment of the certificate proxy server 120 may include a SIP proxy server having, among other elements, a transceiver 122 and a certificate manager module 124. The transceiver 122 may comprise any suitable wired or wireless transceiver, as further described with reference to FIG. 6. The certificate manager module 124 may comprise a physical or logical device arranged to interoperate with the certificate manager module 112 of the call terminal 110 to register a security certificate for the call terminal 110 with the certificate proxy server 120. One example of a security certificate may include without limitation a digital identity certificate 170. Once registration operations have been completed, the certificate manager module 124 may be arranged to manage the digital identity certificate 170 as a proxy or agent for the call terminal 110 by performing one or more authentication and/or certificate management operations on behalf of the call terminal 110.

In cryptography, a security certificate such as the digital identity certificate 170 is an electronic document which incorporates a digital signature to bind together a symmetric key or asymmetric key (e.g., public key and/or private key) with an identity using information such as the name of a person, an organization, an address, a network device, a network address, and so forth. The digital identity certificate 170 may sometimes be referred to as a certificate, a digital certificate, an identity certificate, a public key certificate, and so forth. For example, when implemented as an asymmetric key, the security certificate can be used to verify that a particular public key belongs to an individual. In a typical public key infrastructure (PKI) scheme, the signature will be of a certificate authority, such as a certificate authority 140. In a web of trust scheme, the signature is of either the user (e.g., a self-signed certificate) or other users (e.g., endorsements). In either case, the signatures on a certificate are attestations by the certificate signer that the identity information and the public key belong together.

Security certificates such as the digital identity certificate 170 provide an operator or user a convenient technique to authenticate a network device such as the call terminal 110 with a network service while reducing or eliminating operator intervention. Although convenient, security certificates are management intensive and periodically require various certificate management operations, such as installing a security certificate to a network device, retrieving a security certificate from a certificate authority, accessing a security certificate, monitoring a security certificate for expiration, renewing a security certificate, revoking an expired security certificate, and so forth. Such certificate management operations are typically computationally expensive, and may not be suitable for certain classes of network devices with limited computing resources, such as the call terminal 110. As network appliances, the call terminal 110 are designed with limited processing and memory resources to reduce costs in manufacturing the call terminal 110. As such, it may be difficult for the call terminal 110 to perform the requisite certificate management operations. Furthermore, such certificate management operations may require ubiquitous access to the call terminal 110 in order to perform such certificate management operations, thereby causing the call terminal 110 to constantly remain in an active state. This may cause the call terminal 110 to consume power and communication resources unnecessarily. This may be particularly unsuitable for network appliances such as the call terminal 110 since it typically remains in an inactive state until an operator manually activates the call terminal 110, such as by pushing a button or lifting the handset in order to place a telephone call.

To solve these and other problems, the certificate proxy server 120 may be implemented as a SIP proxy server arranged to operate as a certificate and authentication service proxy. The certificate proxy server 120 may operate as a proxy for a user or operator to convert a security certificate to authentication credentials, and also as a certificate manager for the user. In this model, a user may register its security certificate with the certificate proxy server 120, which will validate and cache the security certificate. The certificate proxy server 120 will subsequently operate as a manager for the stored security certificate and perform authentication and/or certificate management operations on behalf of user. The user as an interested party in the security certificate may request the certificate proxy server 120 to provide appropriate notifications when changes occur to the security certificate. This authentication proxy model assumes that the certificate proxy server 120 is a trusted entity within the relevant domain, and that the security certificate is communicated to the certificate proxy server 120 within a restricted network environment where the probability for breach of contract is reduced to acceptable operational levels for a given set of design constraints and performance parameters.

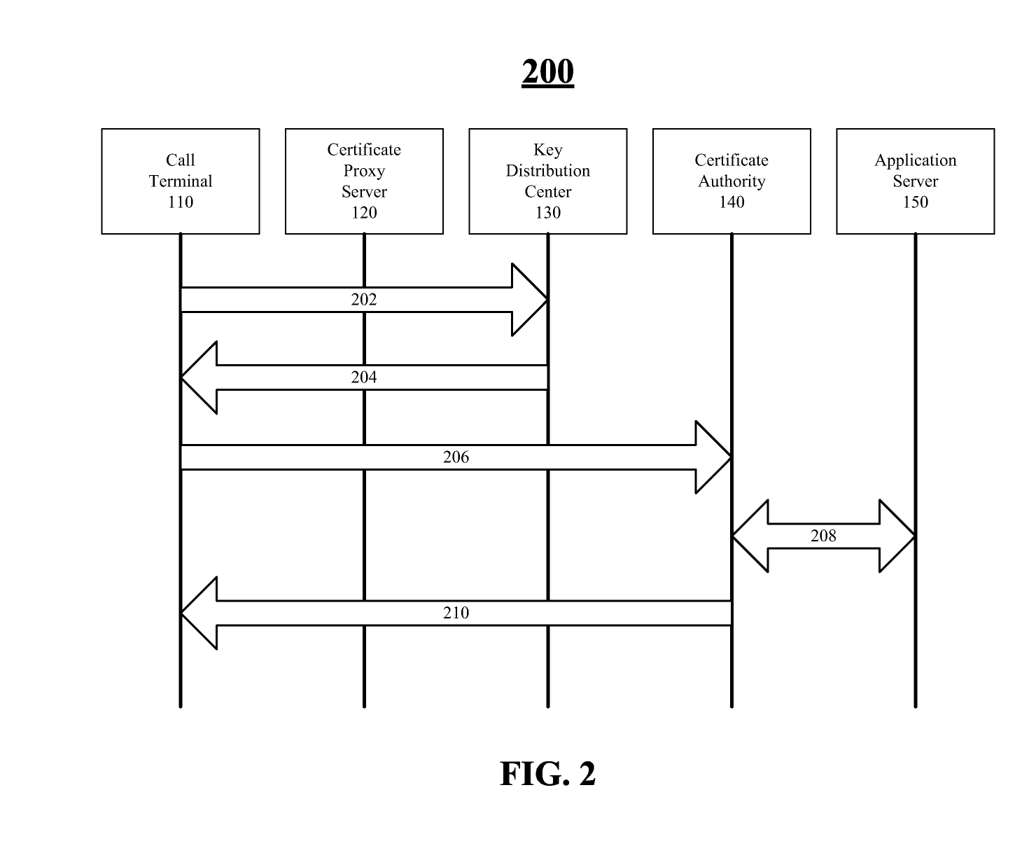

Referring again to FIG. 1, the certificate manager module 112 of the call terminal 110 and the certificate manager module 124 of the certificate proxy server 120 may be designed to interoperate to register the digital identity certificate 170 for the call terminal 110. Once registered, the certificate proxy server 120 may operate to perform authentication operations on behalf of the call terminal 110 using the digital identity certificate 170. Furthermore, the certificate manager module 124 may operate to perform certificate management operations for the digital identity certificate 170 on behalf of the call terminal 110. The operations of the certificate manager modules 112, 124 and the security infrastructure implemented by the communications system 100 may be described in more detail with reference to the message flows shown in FIGS. 2-5.

FIG. 2 illustrates one embodiment of a message flow 200. The message flow 200 illustrates one example of a message flow for the call terminal 110 to request, receive or otherwise obtain the digital identity certificate 170. In various embodiments, the call terminal 110 may receive call terminal authentication information. The call terminal authentication information may comprise any information that provides a secure form of identification for an operator or user of the call terminal 110. The call terminal authentication information should be delivered by some out-of-band mechanism other than the security infrastructure of the communications system 100 to avoid compromise at this initial phase of authentication. For example, the call terminal authentication information may be delivered by regular mail, courier, hand-delivery, authenticated telephone call, and so forth.

In one embodiment, for example, the call terminal authentication information may comprise or be implemented as a smart card certificate stored on a smart card 114. A user can insert the smart card 114 into a smart card reader for the call terminal 110. The smart card reader may retrieve the call terminal authentication information in the form of a smart card certificate. Alternatively, an operator may use another form of authentication to identify the operator, such as a personal identification number (PIN), a cookie, a password, and so forth.

Once received, the call terminal 110 may convert the call terminal authentication information to the digital identity certificate 170. The certificate conversion operations may vary depending upon the type of security infrastructure implemented for the communications system 100. In the illustrated embodiment shown in FIG. 1, for example, the security infrastructure includes a key distribution center 130, a certificate authority 140, and an authentication server 150. Furthermore, the security infrastructure may use an authentication technique such as the Kerberos Network Authentication Service (V5) as defined by the IETF Request For Comment (RFC) 4120, July 2005 (“Kerberos Specification”), and its progeny, revisions and variants. It may be appreciated, however, that the embodiments are not limited to this particular authentication technique.

The Kerberos protocol involves use of a trusted third party known as the key distribution center (KDC) 130 to negotiate shared session keys between clients (e.g., the call terminal 110) and services (e.g., application server 150) and provide mutual authentication between them. The Kerberos protocol utilizes two cryptographic documents referred to as a “ticket” and an “authenticator.” A ticket encapsulates a symmetric key (e.g., the ticket session key) in an envelope (a public message) intended for a specific service. The contents of the ticket are encrypted with a symmetric key shared between the service principal and the issuing KDC 130. The encrypted part of the ticket contains the client principal name, among other items. An authenticator is a record that can be shown to have been recently generated using the ticket session key in the associated ticket. The ticket session key is known by the client who requested the ticket. The contents of the authenticator are encrypted with the associated ticket session key. The encrypted part of an authenticator contains a timestamp and the client principal name, among other items.

The KDC 130 may include a Kerberos authentication server 132 and a Kerberos ticket granting server (TGS) 134. In general, a client and the KDC 130 may engage in three principal types of exchanges, including an authentication service exchange, a ticket granting service exchange, and a client/server authentication protocol exchange. In the authentication service exchange, the client obtains an “initial” ticket from the authentication server 132, typically referred to as a ticket granting ticket (TGT). The AS-REQ message and the AS-REP message are the request and the reply message, respectively, between the client and the authentication server 132. In the ticket granting service exchange, the client subsequently uses the TGT to authenticate and request a service ticket for a particular service from the TGS 134. The TGS-REQ message and the TGS-REP message are the request and the reply message respectively between the client and the TGS 134. In the client/server authentication protocol exchange, the client makes a request with an AP-REQ message to the application server 150. The request may comprise a service ticket and an authenticator that certifies the client's possession of the ticket session key. The application server 150 may optionally reply with an AP-REP message. The client/server authentication protocol exchange typically negotiates session-specific symmetric keys.

Referring again to the message flow 200 shown in FIG. 2, when the certificate authority 140 does not support a particular IETF standard titled “Public Key Cryptography for Initial Authentication in Kerberos (PKINIT)” RFC 4556, June 2006, the call terminal 110 requests a Kerberos ticket (e.g., a TGT) from the KDC 130 as indicated by the arrow 202. The KDC 130 may convert the smart card certificate to a Kerberos ticket, and send the Kerberos ticket to the call terminal 110 as indicated by the arrow 204. The call terminal 110 may send the Kerberos ticket to the certificate authority 140 to request the digital identity certificate 170 as indicated by the arrow 206. The certificate authority 140 may exchange authentication credentials with the application server 150 as indicated by the arrow 208 to create the digital identity certificate 170. The certificate authority 140 may send the digital identity certificate 170 to the call terminal 110 as indicated by the arrow 210. The call terminal 110 may optionally store the digital identity certificate 170 using internal volatile or non-volatile memory.

When the certificate authority 140 does support PKINIT, however, the call terminal 110 may send the smart card certificate to the certificate authority 140 to obtain the digital identity certificate 170 as indicated by the arrow 206. In this case, the call terminal 110 may bypass the exchanges indicated by the arrows 202, 204.

In previous embodiments, such as those described with reference to the message flow 200 shown in FIG. 2, certificate proxy operations were initiated using call terminal authentication information implemented as a smart card certificate stored on a smart card 114. As previously described, a user can insert the smart card 114 into a smart card reader for the call terminal 110. The smart card reader may retrieve the call terminal authentication information in the form of a smart card certificate. Alternatively, an operator may use another form of authentication to identify the operator, such as a personal identification number (PIN), a cookie, a password, and so forth. Once received, the call terminal 110 may convert the call terminal authentication information to the digital identity certificate 170.

In some cases, however, the certificate proxy server 120 may also act as a proxy to retrieve the digital identity certificate 170 directly from the certificate authority 140 on behalf of the call terminal 110. For example, the call terminal 110 may present the certificate proxy server 120 (e.g., over a secure connection) with the smart card certificate retrieved from the smart card 114 (or other out-of-band mechanism). The certificate proxy server 120 may interact with the certificate authority 140 to convert the smart card certificate to the digital identity certificate 170. This technique should occur, however, in a trusted boundary (e.g., within the same domain) to increase attack resistance strength.

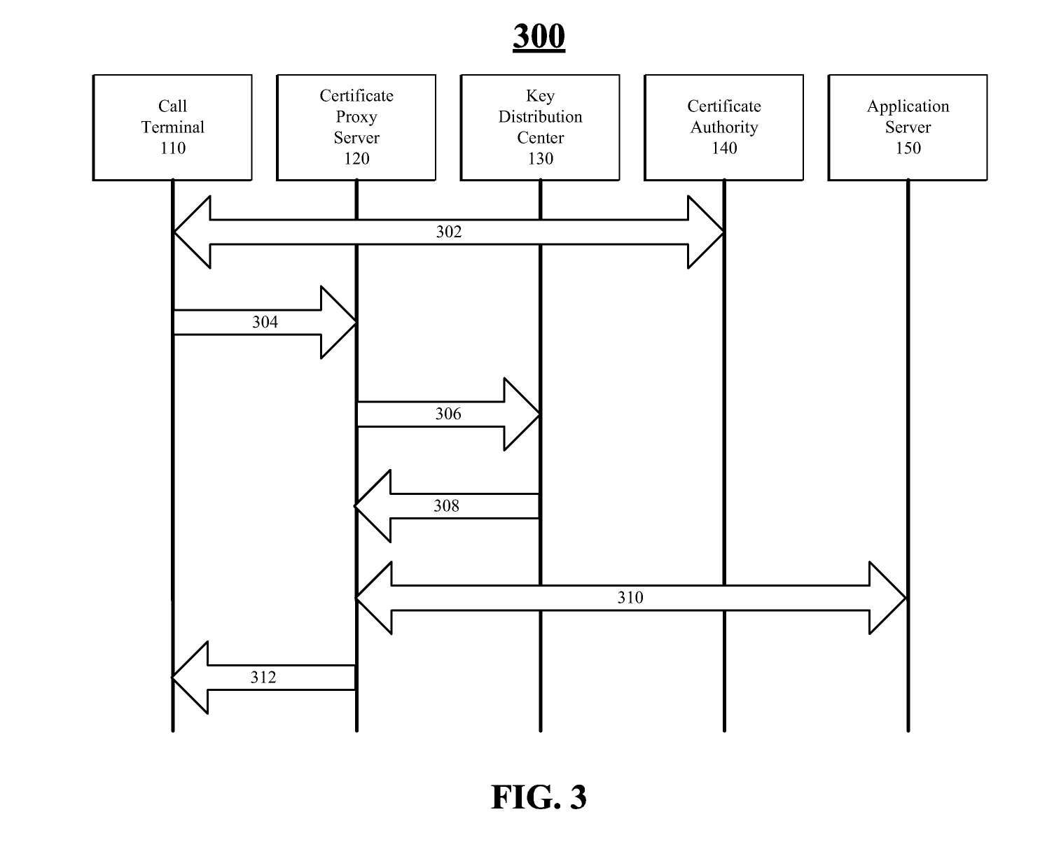

FIG. 3 illustrates one embodiment of a message flow 300. The message flow 300 illustrates one example of a message flow for the certificate proxy server 120 and/or the call terminal 110 to register the digital identity certificate 170 with the certificate proxy server 120. The registration operation allows the certificate proxy server 120 to authenticate the call terminal 110 with the digital identity certificate 170 as a proxy for the call terminal 110. Prior to performing registration operations, the call terminal 110 may retrieve a root certificate from the certificate authority 140 that supports auto-enrollment or web-based certification services as indicated by arrow 302. Alternatively, the call terminal 110 may generate and send a lightweight directory access protocol (LDAP) query to an active directory server (not shown) for retrieving the root certificate.

Once the root certificate has been retrieved, the call terminal 110 may establish a secure connection between the call terminal and the certificate proxy server to register the digital identity certificate with the certificate proxy server. The secure channel may be established using a suitable cryptographic technique. For example, the call terminal 110 and the certificate proxy server 120 may establish an encrypted channel such as a transport layer security (TLS) connection.

Once a secure channel has been established between the call terminal 110 and the certificate proxy server 120, the call terminal 110 may validate the certificate proxy server 120 using the root certificate stored by the call terminal 110. This reduces the probability that the call terminal 110 does not give its digital identity certificate 170 to the wrong device.

Once the certificate proxy server 120 is validated as the correct network device to operate as a proxy for the call terminal 110, the call terminal 110 sends a registration request to the certificate proxy server 120 as indicated by arrow 304. The registration request may include the digital identity certificate 170 and a request to authenticate the call terminal 110 with the digital identity certificate 170 to the application server 150. The call terminal may send a certificate digest and a multipurpose internet messaging extension (MIME) encoded certificate as part of the registration request, among other information.

The certificate proxy server 120 receives the digital identity certificate 170 from the call terminal by the certificate proxy server over the secure connection between the call terminal 110 and the certificate proxy server 120. The certificate proxy server 120 validates the digital identity certificate 170 with its own root certificate stored by the certificate proxy server 120. This ensures that the digital identity certificate 170 is actually received from the call terminal 110 and not another device.

The certificate proxy server 120 authenticates the call terminal 110 using authentication credentials retrieved with the digital identity certificate 170 by the certificate proxy server 120. The authentication credentials may refer to any information acceptable to authenticate the call terminal 110 with the given security infrastructure or the application server 150. An example of authentication credentials may include a Kerberos ticket (e.g., TGT or service ticket) and accompanying information.

The certificate proxy server 120 attempts to retrieve authentication credentials with the digital identity certificate 170 from the KDC 130 for the call terminal 110 as indicated by arrow 306. For example, the certificate proxy server 120 may request a Kerberos ticket (e.g., a TGT) from the KDC 130 using the digital identity certificate 170 as indicated by arrow 306. The KDC 130 may convert the digital identity certificate 170 to a Kerberos ticket, and send it to the certificate proxy server 120 as indicated by arrow 308. The certificate proxy server 120 may optionally validate the call terminal 110 for operation within a given domain by sending the Kerberos ticket to the authentication server 132.

Once the certificate proxy server 120 converts the digital identity certificate 170 to authentication credentials for the call terminal 110, the certificate proxy server 120 may create a record for the digital identity certificate 170 in the certificate database 126. For example, the certificate proxy server 120 may store the digital identity certificate 170, a digital identity certificate expiration date for the digital identity certificate 170, and a digital identity certificate identifier for the digital identity certificate 170, among other information. In some cases, the certificate proxy server 120 may store the record for the digital identity certificate 170 in a secure manner, such as performing a one-way encryption of the digital identity certificate 170 and/or accompanying information prior to saving some or all portions of the record.

Once a record has been created for the digital identity certificate 170 of the call terminal 110, the certificate proxy server 120 may authenticate the call terminal 110 without needing to access the authentication server 132. The certificate proxy server 120 may authenticate the call terminal 110 using the authentication credentials retrieved with the digital identity certificate 170 by the certificate proxy server 120, and stored on the certificate database 126. For example, the certificate proxy server 120 may use the stored TGT to authenticate and request a service ticket for a particular service from the TGS 134 with a TGS-REQ message and TGS-REP message exchange. The certificate proxy server 120 then makes a request with an AP-REQ message to the application server 150 as indicated by arrow 3 10. The request may comprise a service ticket and an authenticator that certifies the client's possession of the ticket session key. The application server 150 may optionally reply to the certificate proxy server 120 with an AP-REP message.

Once authenticated, the certificate proxy server 120 may notify the call terminal 110 that it has been authenticated as indicated by arrow 312. The certificate proxy server 120 may also send the digital identity certificate identifier for the digital identity certificate 170, among other information.

The call terminal 110 may receive the digital identity certificate identifier for the digital identity certificate 170 from the certificate proxy server 120. The call terminal 110 may use the digital identity certificate identifier as a reference for certificate management operations performed for the digital identity certificate 170. For example, the call terminal 110 may subscribe to the certificate proxy server 120 for notifications of digital identity certificate state changes with the digital identity certificate identifier for the digital identity certificate 170. The call terminal 110 may receive notifications from the certificate proxy server 120 of such digital identity certificate state changes with the digital identity certificate identifier. This may be particularly advantageous whenever the call terminal 110 has multiple security certificates managed by the certificate proxy server 120 on its behalf.

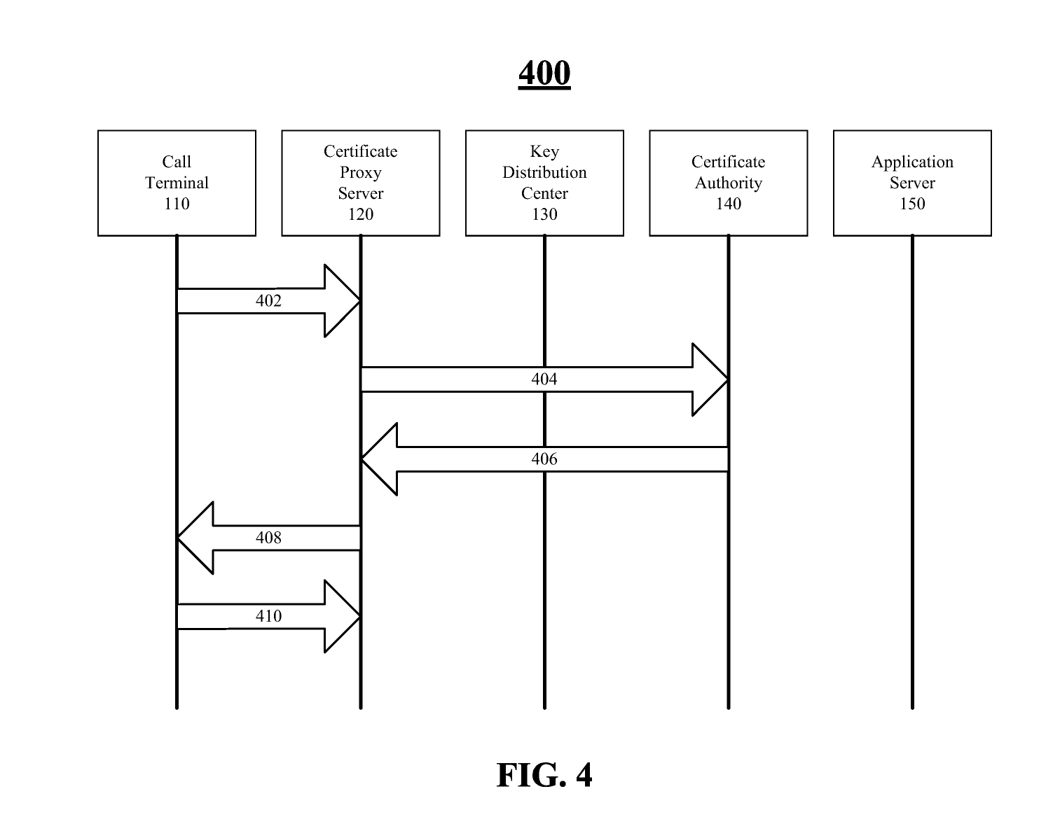

FIG. 4 illustrates one embodiment of a message flow 400. The message flow 400 illustrates one example of a message flow for the certificate proxy server 120 and/or the call terminal 110 to manage the digital identity certificate 170. In addition to authentication operations, the certificate proxy server 120 may also manage the digital identity certificate 170 for the call terminal 110. The certificate proxy server 120 may perform certain certificate management operations for the digital identity certificate 170. Examples of certificate management operations may include without limitation installing the digital identity certificate 170 to a network device, retrieving the digital identity certificate 170 from a certificate authority, accessing the digital identity certificate 170, monitoring the digital identity certificate 170 for expiration, renewing the digital identity certificate 170, revoking the digital identity certificate 170 on expiration, and so forth.

In one embodiment, for example, the certificate proxy server 120 may perform a certificate management operation such as certificate renewal. The message flow 400 illustrates the certificate proxy server 120 renewing the digital identity certificate 170 to form a renewed digital identity certificate 180 when a digital identity certificate expiration date for the digital identity certificate 170 expires. A particular digital identity certificate is typically granted a limited time for use as represented by the digital identity certificate expiration date. The digital identity certificate expiration date may include a particular date and/or time when the digital identity certificate expires. Whenever the assigned time period expires, the digital identity certificate may need to be renewed. Alternatively, the expired digital identity certificate may be revoked and replaced with a new digital identity certificate.

As shown in the message flow 400, the call terminal 110 may subscribe to the certificate proxy server 120 for notifications of digital identity certificate state changes with the digital identity certificate identifier for the digital identity certificate 170 as indicated by arrow 402. The certificate proxy server 120 may include a timer to monitor the digital identity certificate expiration date for the digital identity certificate 170. Upon expiration, the certificate proxy server 120 may send a certificate renewal request to the certificate authority 140 as indicated by arrow 404 and signal path 160. The certificate authority 140 may renew the digital identity certificate 170, as represented by the renewed digital identity certificate 180. The certificate authority 140 may send the renewed digital identity certificate 180, or representative information, to the certificate proxy server 120 as indicated by arrow 406. The certificate proxy server 120 may notify the call terminal 110 of the successful renewal of the digital identity certificate 170, and send the renewed digital identity certificate 180 (or representative information) and the digital identity certificate identifier for the digital identity certificate 170 to the call terminal 110 as indicated by arrow 408.

The call terminal 110 may receive the renewed digital identity certificate 180 and the digital identity certificate identifier for the digital identity certificate 170 previously returned from the certificate proxy server 120. The call terminal 110 may install the renewed digital identity certificate 180 in its volatile or non-volatile memory. The call terminal 110 may send an updated register request to register the renewed digital identity certificate 180 with the digital identity certificate identifier for the digital identity certificate 170 to the certificate proxy server 120 as indicated by arrow 410.

The certificate proxy server 120 may receive the registration request for the renewed digital identity certificate 180 and the digital identity certificate identifier for the digital identity certificate 170 from the call terminal 110. The certificate proxy server 120 may securely replace the digital identity certificate 170 with the renewed digital identity certificate 180 in the certificate database 126.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints. Other anti-spam activities may be interspersed into these operations.

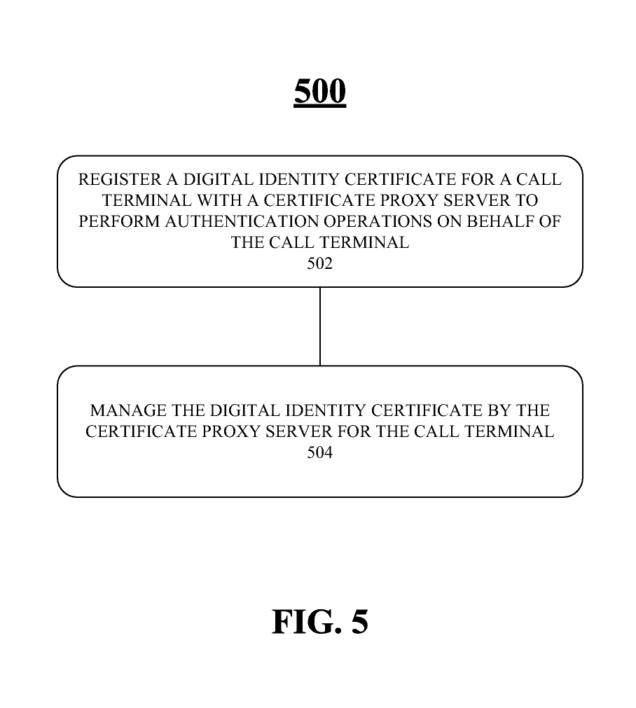

FIG. 5 illustrates a logic flow 500. The logic flow 500 may be representative of the operations executed by one or more embodiments described herein, such as one or more operations performed by the call terminal 110 and/or the certificate proxy server 120, for example. As shown in FIG. 5, the logic flow 500 may register a digital identity certificate for a call terminal with a certificate proxy server to perform authentication operations on behalf of the call terminal at block 502. The logic flow 400 may manage the digital identity certificate by the certificate proxy server for the call terminal at block 504. The embodiments are not limited in this context.

In one embodiment, the logic flow 200 may register a digital identity certificate for a call terminal with a certificate proxy server to perform authentication operations on behalf of the call terminal at block 202. For example, the certificate manager module 124 of the certificate proxy server 120 may receive the digital identity certificate 170 for the call terminal 110. The certificate manager module 124 of the certificate proxy server 120 may retrieve authentication credentials for the call terminal 110 with the digital identity certificate 170 from the KDC 130. The certificate manager module 124 may assign a digital identity certificate identifier for the digital identity certificate 170, and send the digital identity certificate identifier to the call terminal 110.

In one embodiment, the logic flow 200 may manage the digital identity certificate by the certificate proxy server for the call terminal at block 204. For example, the certificate manager module 124 of the certificate proxy server 120 may retrieve the digital identity certificate 170 from the call terminal 110 or the certificate authority 140, access the digital identity certificate 170 from the certificate database 126, monitor the digital identity certificate 170 for expiration, renew the digital identity certificate 170, revoke the digital identity certificate 170 on expiration, and so forth.

FIG. 6 illustrates a block diagram of a computing system architecture 600 suitable for implementing various embodiments. It may be appreciated that the computing system architecture 600 is only one example of a suitable computing environment and is not intended to suggest any limitation as to the scope of use or functionality of the embodiments. Neither should the computing system architecture 600 be interpreted as having any dependency or requirement relating to any one or combination of components illustrated in the exemplary computing system architecture 600.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 6, the computing system architecture 600 includes a general purpose computing device such as a computer 610. The computer 610 may include various components typically found in a computer or processing system. Some illustrative components of computer 610 may include, but are not limited to, a processing unit 620 and a memory unit 630.

In one embodiment, for example, the computer 610 may include one or more processing units 620. A processing unit 620 may comprise any hardware element or software element arranged to process information or data. Some examples of the processing unit 620 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 620 may be implemented as a general purpose processor. Alternatively, the processing unit 620 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 610 may include one or more memory units 630 coupled to the processing unit 620. A memory unit 630 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 610. The embodiments are not limited in this context.

In one embodiment, for example, the computer 610 may include a system bus 621 that couples various system components including the memory unit 630 to the processing unit 620. A system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 610 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 600. Examples of computer readable media for computing system architecture 600 may include, but are not limited to, volatile and/or nonvolatile memory such as ROM 631 and RAM 632. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 630 includes computer storage media in the form of volatile and/or nonvolatile memory such as ROM 631 and RAM 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 684 or other type of display device is also connected to the system bus 621 via an interface, such as a video processing unit or interface 682. In addition to the monitor 684, computers may also include other peripheral output devices such as speakers 687 and printer 686, which may be connected through an output peripheral interface 683.

The computer 610 may operate in a networked environment using logical connections to one or more remote computers, such as a remote computer 680. The remote computer 680 may be a personal computer (PC), a server, a router, a network PC, a peer device or other common network node, and typically includes many or all of the elements described above relative to the computer 610, although only a memory storage device 681 has been illustrated in FIG. 6 for clarity. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through an adapter or network interface 670. When used in a WAN networking environment, the computer 610 typically includes a modem 672 or other technique suitable for establishing communications over the WAN 673, such as the Internet. The modem 672, which may be internal or external, may be connected to the system bus 621 via the network interface 670, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other techniques for establishing a communications link between the computers may be used. Further, the network connections may be implemented as wired or wireless connections. In the latter case, the computing system architecture 600 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system architecture 600 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
registering a digital identity certificate for a call terminal with a certificate proxy server to perform authentication operations on behalf of the call terminal; and
managing the digital identity certificate by the certificate proxy server for the call terminal.

2. The method of claim 1, comprising establishing a secure connection between the call terminal and the certificate proxy server to register the digital identity certificate with the certificate proxy server.

3. The method of claim 1, comprising receiving the digital identity certificate from the call terminal by the certificate proxy server over a secure connection between the call terminal and the certificate proxy server.

4. The method of claim 1, comprising retrieving authentication credentials with the digital identity certificate by the certificate proxy server.

5. The method of claim 1, comprising authenticating the call terminal using authentication credentials retrieved with the digital identity certificate by the certificate proxy server.

6. The method of claim 1, comprising storing the digital identity certificate, a digital identity certificate expiration date, and a digital identity certificate identifier in a certificate database by the certificate proxy server.

7. The method of claim 1, comprising renewing the digital identity certificate to form a renewed digital identity certificate when a digital identity certificate expiration date expires by the certificate proxy server.

8. The method of claim 1, comprising sending a renewed digital identity certificate and a digital identity certificate identifier for the digital identity certificate from the certificate proxy server to the call terminal.

9. The method of claim 1, comprising receiving a registration request for a renewed digital identity certificate and a digital identity certificate identifier for the digital identity certificate from the call terminal by a certificate proxy server.

10. The method of claim 1, comprising replacing the digital identity certificate with a renewed digital identity certificate by the certificate proxy server.

11. An article comprising a storage medium containing instructions that if executed enable a system to:
receive call terminal authentication information by a call terminal;
convert the call terminal authentication information to a digital identity certificate; and
register the digital identity certificate with a certificate proxy server to allow the certificate proxy server to authenticate the call terminal with the digital identity certificate as a proxy for the call terminal.

12. The article of claim 11, comprising instructions that if executed enable the system to receive a digital identity certificate identifier for the digital identity certificate from the certificate proxy server by the call terminal.

13. The article of claim 11, comprising instructions that if executed enable the system to subscribe to the certificate proxy server for digital identity certificate state changes with a digital identity certificate identifier for the digital identity certificate.

14. The article of claim 11, comprising instructions that if executed enable the system to receive a renewed digital identity certificate and a digital identity certificate identifier for the digital identity certificate from the certificate proxy server by the call terminal.

15. The article of claim 11, comprising instructions that if executed enable the system to register a renewed digital identity certificate and a digital identity certificate identifier for the digital identity certificate to the certificate proxy server from the call terminal.

16. An apparatus comprising a certificate proxy server arranged to operate as a certificate proxy for a call terminal, the certificate proxy server having a transceiver and a certificate manager module, the certificate manager module operative to register a digital identity certificate for the call terminal to perform authentication operations on behalf of the call terminal, and manage the digital identity certificate for the call terminal.

17. The apparatus of claim 16, the certificate proxy server comprising a session initiation protocol proxy server, and the certificate manager module operative to receive the digital identity certificate from the call terminal over a secure connection between the call terminal and the session initiation protocol proxy server, and retrieve authentication credentials with the digital identity certificate.

18. The apparatus of claim 16, the certificate manager module operative to authenticate the call terminal using authentication credentials retrieved with the digital identity certificate.

19. The apparatus of claim 16, comprising a certificate database to couple to the certificate manager module, the certificate manager module operative to securely store the digital identity certificate, a digital identity certificate expiration date, and a digital identity certificate identifier in the certificate database.

20. The apparatus of claim 16, the certificate manager module operative to renew the digital identity certificate to form a renewed digital identity certificate when a digital identity certificate expiration date expires, send the renewed digital identity certificate and a digital identity certificate identifier for the digital identity certificate to the call terminal, receive a registration request for the renewed digital identity certificate and the digital identity certificate identifier from the call terminal, and replace the digital identity certificate with the renewed digital identity certificate in a certificate database.
